(19) United States
(12) Patent Application Publication
(10) Pub. No.: US 2024/0123659 A1
(43) Pub. Date: Apr. 18, 2024

(54) MOLD AND METHOD FOR MOLD FORMING PRODUCTS

(71) Applicant: PaperFoam Holding B.V., Barneveld (NL)

(72) Inventors: Jochem Alex BLUM, Arnhem (NL); Nynke Margaretha ZANDSTRA, Amersfoor (NL); Menno Eduard GROENEVELT, Velp (NL); Jan Wietze HUISMAN, Wilp (NL)

(73) Assignee: PaperFoam Holding B.V., Barneveld (NL)

(21) Appl. No.: 18/278,134

(22) PCT Filed: Feb. 21, 2022
(86) PCT No.: PCT/NL2022/050090

§ 371 Date: Aug. 21, 2023

(30) Foreign Application Priority Data
Feb. 22, 2021 (NL) 2027614

(51) Int. Cl. B29C 45/14; B29C 45/17; B29C 45/34; B29C 45/73

(52) U.S. Cl. CPC B29C 45/14008; B29C 45/1706; B29C 45/345; B29C 45/73; B29C 2045/2693; B29C 2945/76498; B29C 2945/76615

(57) ABSTRACT

The invention relates to a mold, comprising at least one mold cavity defined by at least a mold wall, wherein at least one part of said wall is a porous part, wherein the at least one porous part is formed by or comprises a porous insert inserted into an opening extending into and preferably through said wall

The invention relates to molds for forming products. The invention relates to molds for forming products using heat, during which forming vapor is generated inside the mold, which has to be removed. The invention further relates to a method for forming products from a batter by heating said batter inside a mold cavity generating vapor which is removed from the mold cavity.

WO96/30186 discloses molds for injection molding products from a mass comprising at least natural polymers such as starch, using an injection mold having at least one mold cavity. The mass is heated inside the mold cavity, such that the mass gelatinizes and is baked, forming a sufficiently form stable product. One or more open deaeration channels are formed, out of the mold cavity, for expelling vapor from the mold cavity. A disadvantage of this known mold is that the vapor, acting as blowing agent, is directly expelled from the mold, which may lead to uncontrolled foaming in the mold cavity. Moreover batter will be expelled through the deaeration channels, which may clog the deaeration channels and will lead to undesirable plumes formed on the surface of the products, which will not be baked and will hence be sticky and flexible. These plumes have to be removed from the product surface, which is time consuming and difficult, especially due to their flexibility and stickiness. Whereas moreover this leads to undesirable waste of material and surface imperfections of the product.

WO2004033179 discloses a mold for forming products from a liquid batter, in which some of these problems are overcome. This known mold is provided with one or more deaeration channels connected to an overdose space inside the mold, in which an overdose of batter is received and is baked, at least to such extend that the plumes formed are not or at least less sticky and less flexible, such that they can be removed more easily. Moreover, the overflow of material is kept inside the mold and thus pollution of the surroundings of the mold is prevented, whereas the forming of foam structure inside the mold cavity can be better controlled.

This known mold however has the disadvantage that it is more complex in construction and operation and maintenance. Moreover, in this mold still plumes are formed which have to be removed from the product and discharged, whereas these plumes are waste material. Furthermore removal of the plumes will lead to imperfections in the skin of the product.

An aim of the present disclosure is to provide an alternative mold. An aim is to provide a mold which reduces and preferably avoids the disadvantages of existing molds. An aim of the present disclosure is to provide a mold for baking products from a batter, in which the batter is prevented from flowing out of the at least one mold cavity. An aim of the present disclosure is to provide a mold preventing or at least reducing waste material and contamination of a working area around the mold during use. An aim is to provide an alternative method for forming products in a mold, especially baking products in a mold.

In a first aspect a mold according to the disclosure comprises at least one mold cavity defined by at least a mold wall, wherein at least one part of said wall is a porous part. The at least one porous part is formed by or comprises a porous insert inserted into an opening extending into said wall. The porous insert preferably extends through said wall.

The mold according to the disclosure is preferably a baking mold, for heating a batter to such temperatures that a product is baked inside the at least one mold cavity. A mold according to the disclosure preferably is an injection mold for baking batter into products. A batter used in a mold or method according to the disclosure preferably comprises at least natural polymers, such as starch.

In a mold according to the disclosure any vapor accumulating inside the at least one mold cavity can be expelled through the at least one porous insert, whereas the batter will be kept inside the at least one mold cavity by at least the porous insert or inserts. The batter will be generally inhibited from flowing into the porous insert, whereas vapor can escape through the porous insert or inserts. The porosity of the porous insert can be chosen depending on the batter to be used in the mold.

In an aspect a mold according to the disclosure can comprise at least one porous insert which comprises a porous body. The porous body can in embodiments be made of metal, such as for example but not limited to bronze, aluminum or steel. Alternatively a porous insert or a body thereof can be made of ceramics. A porous insert or a porous body thereof can be made by sintering. In embodiments the porous body can be comprised in a sleeve.

In an aspect a mold of the disclosure can be designed such that the at least one porous insert forms a first vent for the mold cavity, wherein at least one further vent is provided for the mold cavity. Such further vent can for example be a slit vent at or near a closure surface of the mold or at an insert element.

In advantageous embodiments the at least one porous insert has a porosity of at least 15%, preferably at least 20%. The porosity has to be understood as the ratio between the volume of the combined pores in an insert or insert body and the total volume of the porous insert or porous body, given as a percentage.

In embodiments of a mold of the disclosure the at least one mold cavity has a cavity surface and each porous insert has a porous surface in the cavity surface, facing the mold cavity. Preferably the porous surface is substantially flush with the further cavity surface. The porous surface can be flat or profiled, for example curved, undulated or otherwise non-flat. In embodiments the porous surface of the one porous insert or the combined porous surfaces of the porous inserts has a surface area which is smaller than half of a surface area defined by the cavity surface, for example less than a quarter, such as for example but not limited to between 2% and 25%, such as for example between 2% and 20% of the total surface are defined by the cavity surface.

A mold according to the disclosure comprises preferably at least one heating element for heating the mold, or at least the at least one mold cavity and baking a batter inside said at least one mold cavity.

In embodiments the mold is provided with or connected to an injector for batter into the mold cavity. In embodiments a pump is connected to the at least one porous insert, wherein the pump can be a reversible pump. Alternatively for example a venturi can be used for creating a decrease in pressure, such as a near vacuum in or near the porous body, in order to remove gas and moisture, wherein a three way valve can be used for switching between increasing pressure and decreasing pressure.

In advantageous embodiments the at least one porous insert is removably mounted in said mold wall, such that it can be cleaned outside the mold.

In an aspect of the disclosure a method for baking a product from a liquid batter in a mold, the mold comprising a mold cavity defined by at least a mold wall, can be characterized in that a batter is injected into the at least one mold cavity and is heated inside said at least one mold cavity, during heating generating vapor from a liquid in the batter, which vapor creates pressure inside the at least one mold cavity and which vapor is removed from the at least one mold cavity at least during said heating, wherein said vapor is removed from the at least one mold cavity at least through at least one porous insert provided in said mold wall, whereas the batter is kept inside the at least one mold cavity at least by the at least one porous insert.

In a method according to the disclosure preferably a batter is used comprising at least natural polymers, such as starch, and water. The batter will be heated inside the mold cavity, such that the batter, especially the natural polymers, gelatinize and subsequently is baked, forming a product.

Preferably the pore sizes of a porous insert is chosen such that solid matter such as non-gelatinized natural polymers in the batter cannot pass into or through the pores from the mold cavity.

In embodiments of a method of the disclosure a mold is used in which the porous inserts have a combined surface area facing the at least one mold cavity, wherein a product formed inside the at least one mold cavity has a dry weight and wherein the ratio of the combined surface area for the or each mold cavity and the dry weight of the product formed therein is between 0.07 and 0.7 cm²/gram, preferably between 0.25 and 0.7 cm²/gram, such as between 0.3 and 0.5 cm²/gram.

In embodiments of a method of the disclosure during heating of the batter inside the at least one mold cavity a vapor pressure is created of between 1.5 and 6 bar overpressure, such as between 1.5 and 4 bar over-pressure. With such pressure a complete filling of the mold cavity or cavities is achieved, as well as proper foaming inside the mold and forming of a desired skin on the or each product formed.

In advantageous embodiments after heating the batter inside the at least one mold cavity the mold is opened and a gas under pressure is inserted through at least one porous insert into the mold cavity, forcing a product formed in the at least one mold cavity out of the mold cavity. This reduces or even mitigates the necessity of ejectors in the mold, such as mechanical ejectors. Preferably prior to inserting the gas under pressure through the at least one porous insert, vapor and condensed vapor is removed by reducing pressure. By reducing pressure behind the porous bodies, vapor and/or condensate are removed before the product is forced out of the mold, preventing the vapor and especially condensate to be blown onto the products.

In a further aspect of the disclosure a method is disclosed for forming a mold, wherein a mold having at least one mold cavity is formed, wherein into, preferably through a wall of said at least one mold cavity at least one opening is formed, into which at least one opening an insert is inserted, wherein the insert is formed having at least a porous body, such that during use vapor generated in the mold cavity can be removed therefrom through the at least one porous body. In embodiments the at least one opening can be drilled or milled into or through said wall.

In clarification of the disclosure and the invention disclosed herein, exemplary embodiments of an apparatus and method according to the disclosure are further elucidated hereafter, with reference to the drawing. The drawing shows schematically in:

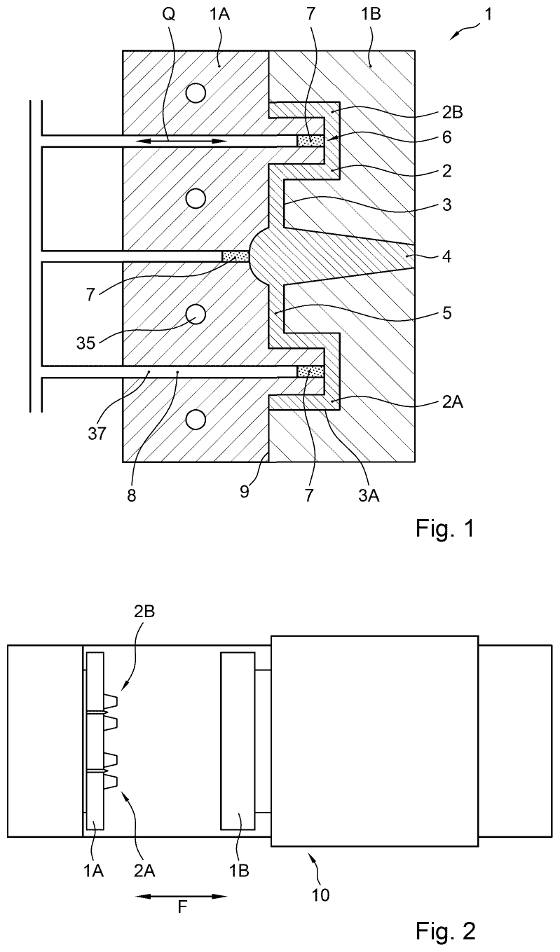

FIG. 1 in cross section, part of a mold;

FIG. 2 a mold, in open position, in a molding device;

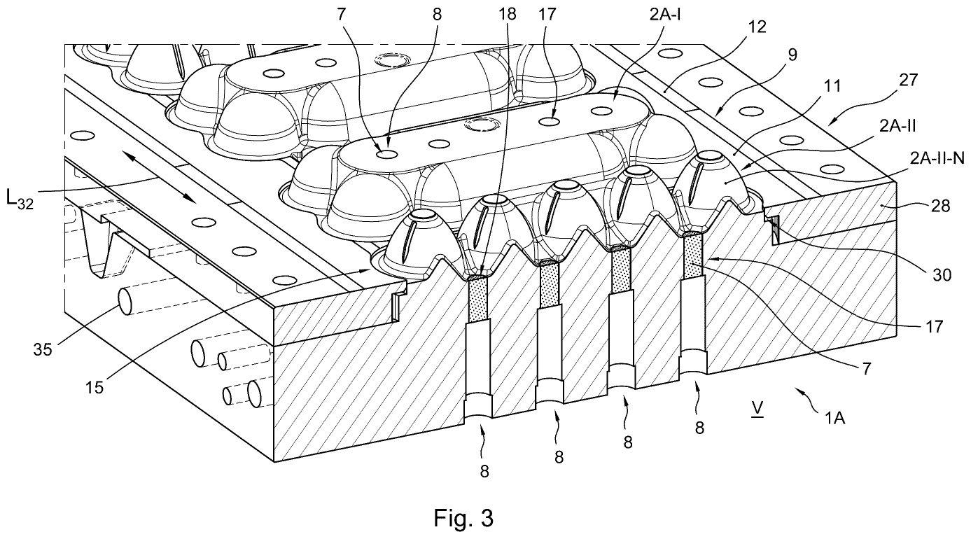

FIG. 3 partially in cross section part of a mold, showing deaeration channels;

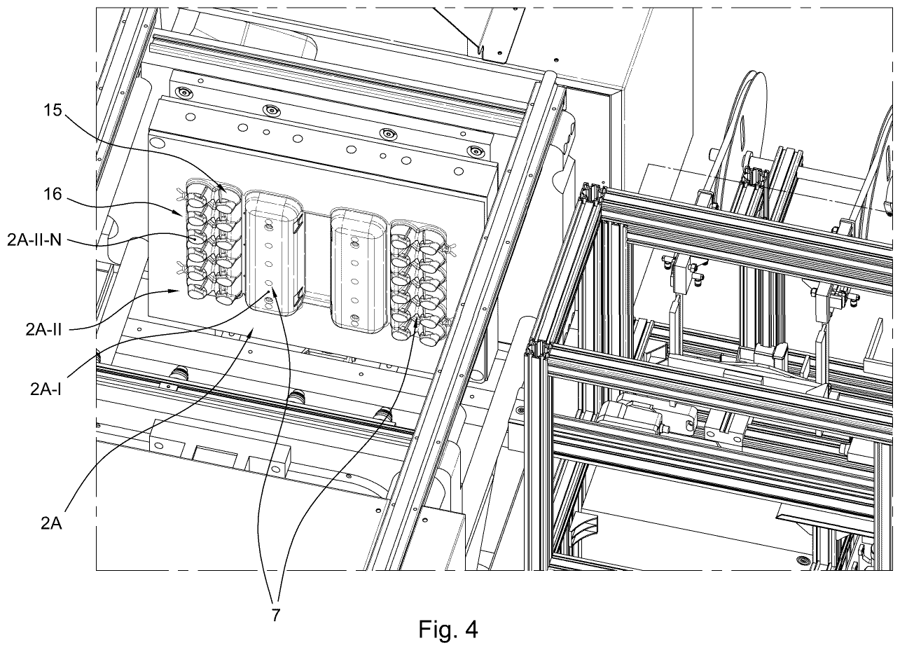

FIG. 4 a mold in open position, showing a female mold halve, and a hinge paper station;

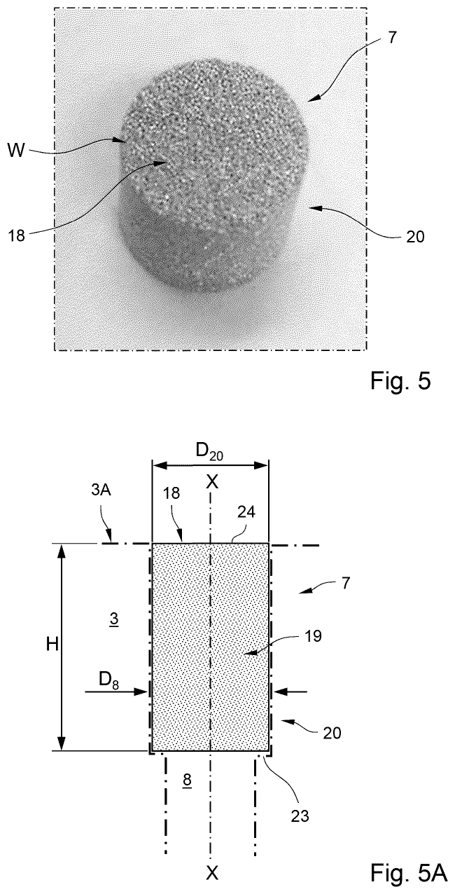

FIG. 5 a porous body for use in a mold;

FIG. 5A is cross section a porous body of FIG. 5 in an opening in a mold;

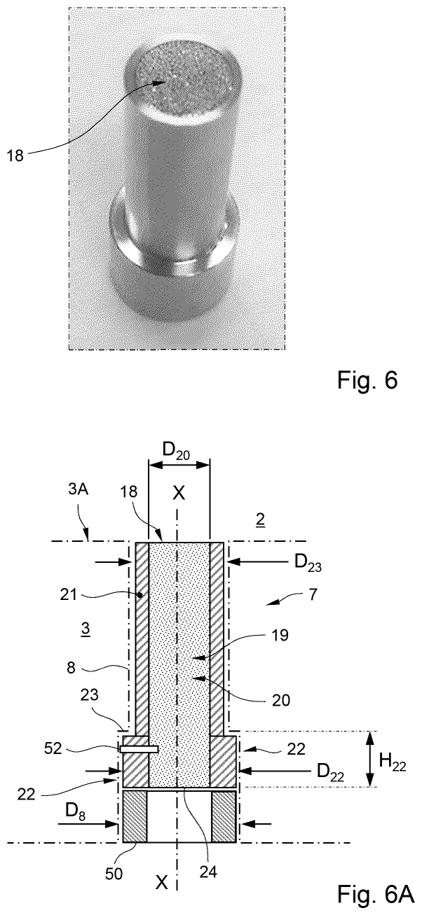

FIG. 6 a porous insert for use in a mold;

FIG. 6A in cross section a porous insert of FIG. 5 in an opening in a mold;

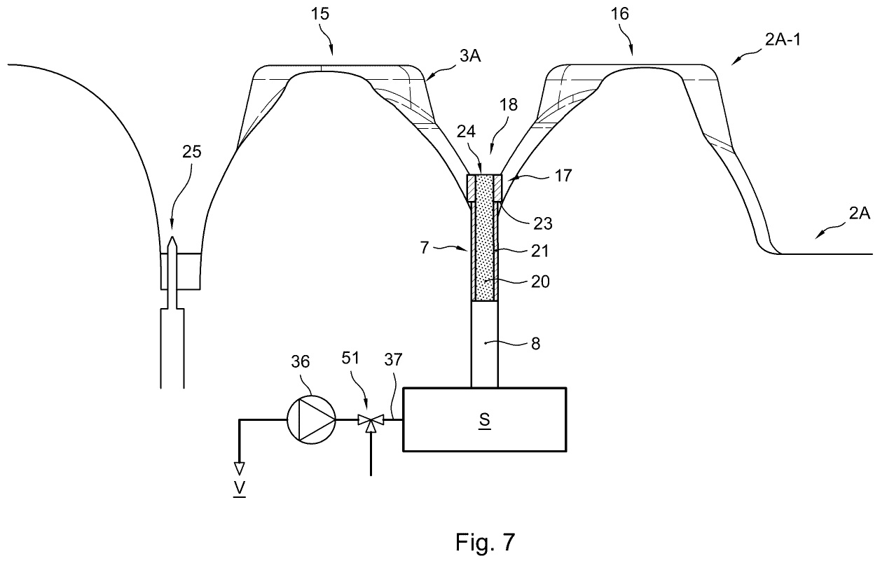

FIG. 7 in cross section part od a female part of a mold;

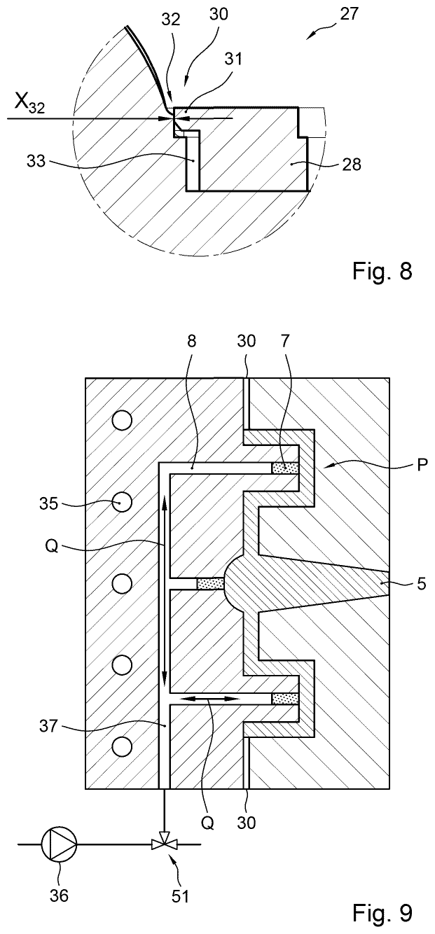

FIG. 8 in cross section part of a deaeration channel of a mold;

FIG. 9 an alternative embodiment of a mold, in cross section; and

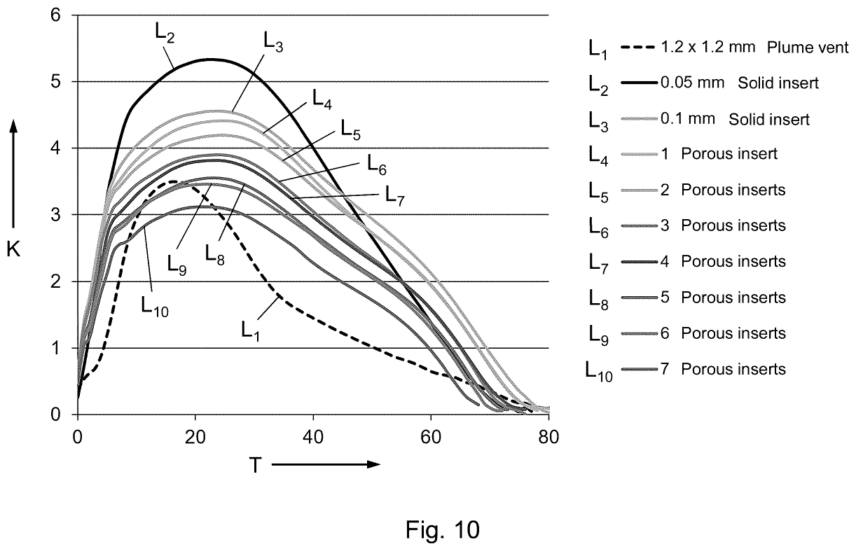

FIG. 10 a graph showing pressure and cycle time for different mold configurations.

In this description the same or similar parts have the same or corresponding reference signs. In this description primarily molds are disclosed which can be used for baking products from a batter using heat. Batter should be understood at least as meaning a suspension of at least a liquid, such as but not limited to water, and natural polymers, such as but not limited to starch. A batter can preferably be sufficiently fluid to be inserted into mold cavities of molds through an injector. However, a batter can also be less fluid, such as a dough, and the batter can be introduced into an open mold, like a platen set, to be compressed in the mold. Various aspects of a mold according to the disclosure can also be used for other molds, like molds for forming plastic products, such as but not limited to injection molds and thermoforming molds.

In this disclosure by way of example packaging products are disclosed, formed in molds. The products shown are specifically packaging products for eggs. Such products are known in the art and specific embodiments of such products are for example disclosed in US2019/0367221. However, obviously also different products can be formed using molds and methods according to the disclosure, such as for example known from U.S. Pat. No. 6,641,758.

In this disclosure a product such as an insert or body being porous or having porosity has to be understood at least as meaning that the product has minute interstices through which a gas, such as for example but not limited to air, and vapor, such as but not limited to water vapor can pass. Porosity of such product can be understood as the ratio, expressed as a percentage, of the volume of the pores or interstices of the product, to the total volume of the product. A porous product can be made of or as a solid material or as or from a non-solid mass, such as a kneadable mass. In this disclosure a porous body should be understood as meaning at least but not limited to a body having porosity such that gas and vapor as discussed can pass through said body. A porous body can be entirely porous or can be porous in part. A porous insert can be a porous body or can be an element or configuration comprising at least one porous body.

In this disclosure wording like substantially and about should be understood at least in their normal meaning, indication that a numerical value or positional reference it relates to can vary, for example with 25% or less, such as for example 15% or less, such as for example 5% or less, unless specifically indicated differently.

FIG. 1 shows schematically, in cross sectional view, a mold 1 according to the disclosure, comprising at least one mold cavity 2 defined by at least a mold wall 3. In the embodiment shown the mold 1 comprises two mold cavities 2A, 2B, connected to each other and to an inlet channel 4 for feeding material 5 into the mold cavities 2. It will however be clear that a mold 1 could alternatively comprise only one mold cavity 2 or more than two mold cavities 2. The inlet channel 4 can be connected to any system for feeding said material 5 into the mold, such as but not limited to an injector (not shown) for injecting material, such as batter into the mold. Such injector is for example disclosed in U.S. Pat. No. 6,641,758, incorporated herein by reference. At least one part of the wall 3 is a porous part 6, which porous part is formed by or comprises a porous insert 7 inserted into an opening 8 extending into said wall 3. In the cross section of FIG. 1 three such inserts 7 can be seen.

The mold 1 in the embodiment shown comprises two mold parts 1A, 1B, which fit together at a closure surface 9, in a known manner, forming the mold cavities 2. The mold parts 1A, 1B can be provided in a mold press 10, as shown in FIG. 2, which can open the mold 2 to the open position as shown in FIG. 2 and in a closed position, as shown in FIG. 1, as known in the art. Each mold part 1A, 1B can comprise different assembled parts or one part only. As can be seen in FIG. 2 the closure surface 9 can extend substantially vertically, an opening and closing direction F extending substantially horizontally. However, the closure surface 9 and opening and closing direction F can also be orientated differently.

FIG. 3 shows part of a mold part, especially a male mold part 1A, of a mold 1, partially in cross section, showing the closure surface 9 and cavity wall portions 11, 12 for defining interior parts of a product to be formed with the mold 1. As will be clear for the skilled person the female mold part 2B will have the complementary cavity wall parts for forming outer surface parts of the product to be formed with the mold 2, as is schematically shown in FIG. 1. In FIG. 3 a male mold part 1A is shown comprising two male parts for forming egg packagings, side by side, each comprising a lid forming portion 2A-1 and a bottom forming portion 2A-II. Of the right hand side male mold part 2A in FIG. 3 only half of the bottom forming portion 2A-II is shown, showing one row 15 of egg receiving cavity forming elements 2A-II-N. A second row 16 of such elements 2A-II-N is connected thereto in mirrored position, as can be seen in FIG. 4. Between these two rows 15, 16 a series of four openings 8 is provided, extending through the wall 3 of the mold 1. In this embodiment the openings 8 form channels between the mold cavity 2 and the environment V of the mold 2. At a mold cavity sided first end 17 of each opening 8 a porous insert 7 is provided, having an end 18 forming part of the mold wall 3 forming the cavity 2. A similar series of openings 8 is provided in the lid forming portion 2A-I, again having a porous insert 7 provided in a cavity 2 sided first end 17 of the respective openings 8.

During use, when the mold 1 is closed, batter introduced into the mold cavity 2 will be prevented from flowing into the openings 8 by the porous inserts 7. The porosity of the porous inserts 7 and the sizes of the interstices 19 or pores at least at the end 18 facing the relevant mold cavity 2 is such that the batter 5 will be prevented from flowing into these interstices or pores 19, for example due to surface tension of the batter 5 and insert 7.

FIG. 5 shows in perspective view an embodiment of a porous insert 7, formed by a porous body 20. In this embodiment the porous body 20 has a substantially cylindrical shape with a diameter D₂₀ and a height H perpendicular to the diameter D₂₀, as shown in FIG. 5A. For fitting an insert 7 according to FIGS. 5 and 5A into an opening 8 the opening 8 can for example be drilled with a diameter Ds corresponding to the outer diameter D₂₀ of the porous body 20, at least over a depth corresponding to the height H of the porous body 20, wherein the further opening 8 can be slightly narrower, as shown in FIG. 5A in striped lines, forming a shoulder 23 against which the porous body 20 can abut, defining the insertion depth for the insert 7.

FIG. 6 shows in perspective view a further embodiment of a porous insert 7, formed by a porous body 20 enclosed in a sleeve 21. In this embodiment the porous body 20 has a substantially cylindrical shape with a diameter D and a height H perpendicular to the diameter D, as shown in FIG. 6A. whereas the sleeve 21 is preferably non-porous. The sleeve 21 in this embodiment comprises a first portion 22 having an outer diameter D22 and a height H22, and a second portion 23 connected to the first portion 22 having a second diameter D23, which is smaller than the diameter D22 of the first portion 22. The porous body 20 can be press fit into the sleeve 21, or can be held in another way in the sleeve 21, for example by adhering, filling the interior of the sleeve 21. For fitting an insert 7 according to FIGS. 6 and 6A into an opening 8 the opening 8 can for example be drilled with a diameter D8 corresponding to the outer diameter D22 of the first portion 22 of the sleeve 21, over a depth corresponding to the height H22 of said first portion 22, wherein the further opening 8 can be slightly narrower, as shown in FIG. 6A in striped lines, forming a shoulder 23 against which the first portion 22 of the sleeve 21 can abut, defining the insertion depth for the insert 7. The porous body 20 is fixed inside the sleeve 21 by a pin 52 or by any other suitable means, including but not limited to adhering, press fitting or the like.

In the embodiments of FIGS. 5 and 6 the inserts 7 have a rotational symmetrical configuration around a longitudinal axis X-X. This can be advantageous since this will allow simple drilling for forming the openings 8 into which the inserts 7 have to be fit. However, porous inserts for use in the disclosure can have any shape or configuration, as long as the porosity of the porous insert 7 allows gas or vapor to be evacuated from a mold cavity and/or allows gas or vapor to be introduced into the mold cavity, whereas material used for forming a product in the mold cavity, especially batter, is prevented from leaving the mold cavity 2 through the porous insert 7. A porous insert 7 can for example have a rectangular cross section, such as a square cross section, an oblong or elliptical cross section, a hexagonal or otherwise multi angled cross section, symmetrical or non-symmetrical or any other suitable shape.

In the embodiments of FIGS. 5 and 6 the porous body 20 and the sleeve 21 have a substantially flat end surface 24 at the first end 18 facing the cavity 2. The end surface 24 can however also be non-flat, such as for example but not limited to curved, semi-spherical, dome shaped or otherwise adapted to the adjoining wall surface 3A of the mold cavity 2. Cylindrical porous bodies 20 can for example have, but are not limited to, a diameter of 10 mm and a height of 10 mm or a height of 3 mm, or a diameter of 5 mm and a height of 3 mm or a height of 10 mm, or a diameter of 14 mm with a height of 3 mm, or a diameter of 100 mm and a height of 10 mm. As discussed, the different sizes can be chosen depending of mold requirements.

FIG. 7 shows part of a mold part 2A in cross section, showing the two rows 15, 16 of elements forming the bottom portion 2A-I of a product P and part of the lid forming portion 2A-II of the product P, with a hinge forming portion 25 there between. Between the rows 15, 16 an opening 8 is shown, in which a porous insert 7 according to FIG. 6 is provided. The end surface 24 of the porous insert 7 forms part of the mold wall surface 3A. The porous insert 7 preferably has been inserted into the opening 8 from the side opposite the cavity side end 17 of the opening 8. Especially if a shoulder 23 or similar element is used in the opening 8 for defining the insertion depth thereof, as shown in and discussed with reference to FIGS. 5A and 6A. By such insertion the advantage can be achieved that the insert 7 can be placed easily and can easily be maintained in place, inter alia by pressure build up in the mold cavity 2. In the embodiment of FIG. 5A the porous insert 7 is inserted from the cavity 2 into the channel 8. In FIG. 6A the porous insert 7 is inserted into the channel 8 from a side opposite the cavity 2, and locked in the channel 8 by a hollow bolt 50 or clip or the like.

As can be seen in the drawing a single porous insert 7 can be provided in a mold 1, but preferably multiple porous inserts 7 are provided in a mold 1, especially for each mold cavity 2, such that at various positions in the mold cavity 2 a channel is provided connecting the mold cavity 2 with an area outside the mold cavity 2, for example the environment V of the mold 1 or a space S inside the mold 1 separated from the mold cavity 2, as schematically shown in FIG. 7, which space S can during use be used for example for collecting gas and/or vapor expelled from the mold cavity 2 and removing this from the mold 1, for example using a pump 36. In a mold 1 according to the disclosure preferably at least five porous inserts 7 are provided, more preferably at least five such porous inserts 7 per mold cavity. This allows for porous inserts 7, especially porous bodies 20 having a relatively small cross section compared to the total surface area of the mold cavity wall 3.

The or each porous insert 7 forms a first vent for a mold cavity 2, allowing gas and vapor to be expelled from the mold cavity 2. Obviously gas or vapor can be introduced into the mold cavity 2 too through the or each porous insert 7. For example, after moulding a product P in a mold cavity 2 and opening of the mold 1, as gas such as air can be forced into the mold cavity 2 through the insert or inserts 7, such that the product P is forced out of the mold cavity 2, to be removed. This overcomes or at least reduces the need for ejectors, such as mechanical ejectors, like push rods traditionally pushing against a product P for forcing it out, which may damage the product P and is moreover complicated in production, use and maintenance.

In embodiments, as for example shown in FIG. 3 and FIGS. 8 and 9 the closure surface 9 of the mold 1 can comprise multiple elements. In the embodiment of FIG. 3 an edge portion 27 of the closure surface 9 is formed by one or more edge elements 28, which can also be referred to as a collar 28, which together with the further mold part 2A provides for an additional, further or second vent 30 for the mold cavity, as is further elucidated in FIG. 8 showing a cross section of such edge portion 27. The edge element or edge elements 28 has or have a nose portion 31 which is positioned in close proximity of the mold cavity surface 3A, defining a slit 32 in between them having a width X₃₂ of between 0.01 and 0.2 mm, such as between 0.03 and 0.15 mm, more preferably between 0.05 and 0.1 mm, a length L₃₂ along the edge portion 27 being substantially longer. Between the edge portion 27 and an adjacent part of the mold part 2A a chamber 33 is provided, connected to the slit 32, which chamber can vent for example to the surrounding V of the mold or to the or a similar space S as disclosed in FIG. 7. By providing a slit 32 having such small width, again gas and vapor can escape from the mold cavity 2 whereas the material 5, especially batter, is prevented from entering into the chamber 33.

Additionally or alternatively to a second vent 30 as discussed here above, a second or further vent can be provided with similar slits 32 which can be provided between for example a solid insert in a mold cavity 2 and a mold cavity surface 3A and/or between closure surfaces 9 of the mold 1. It has been found that by providing a combination of first vents by porous inserts 7 and second vents 30 as discussed, the second vents 30 can be designed such that they are relatively effective in expelling gas and vapor from a mold cavity 2 without allowing material 5, especially batter, to enter into and/or through the vents 30 or clogging the vents 30. Moreover it has been found that providing additional vents as discussed will allow for optimizing pressure build up inside the mold cavity or cavities 2 when baking batter inside the mold 1.

In the embodiments shown the openings 8 form substantially straight channels, and have a direction Q of flow substantially perpendicular to the closure surfaces 9 of the mold 1. It will however be clear that the openings 8 can form channels having different directions Q of flow, for example substantially parallel to the closure surfaces 9, as schematically shown in FIG. 9, upward or downward, or to a side of the mold. Alternatively the channels can all or in part extend at an angle to said surface 9 other than about 90 degrees or 0 degrees, for example but not limited to an angle between 1 and 89 degrees, such as for example between 30 and 60 degrees, and such channels can comprise curves or otherwise changes in direction of flow, as long as gas and/or vapor can be removed from a mold cavity 2 using such channel or channels.

A porous insert 7 or at least a porous body 20 for use in the present disclosure can be made of for example metal, plastic or ceramics, in any suitable way, as is known in the art. In embodiments a porous insert 7, or at least a porous body 20 can be made using sintered material, especially sintered metal or ceramics. In embodiments the porous insert 7, especially the porous body 20 can be made of bronze, such as but not limited to sintered bronze, steel, such as but not limited to austenitic or stainless steel, such as for example but not limited to AISI 316L steel, or porous aluminum. Examples of such materials are further specified in table 1, wherein the porous aluminum can for example be filter grade with a pore size of between 40 and 50 μm. Bronze may be beneficial in that it is less prone to rust forming by oxidation than for example steel and may be less brittle than porous aluminum.

TABLE 1
suitable materials for porous inserts

| Material | Chemical Composition |
|---|---|
| 89/11 sintered bronze | Sn: 10-11.5%, others: 2% max, Cu: rest |
| Sintered austenitic AlSI 316L | Cr: 16-18% |
| or AlSI 316 Stainless Steel | Ni: 11-14% |
| | Mo: 2-3% |
| | C: <0.03% |
| | Others: 2% max., |
| | Fe: Rest |
| Porous Aluminum | AlSi7Mg |

A porous body 20 for use in the present invention preferably has a porosity of at least 15%, more preferably at least 20%. The porosity can for example be between 15% and 70%, preferably between 20% and 70%, such as for example between 20% and 65%. For example for porous bodies 20 made of bronze the porosity can be between about 20% and 50%, for steel porous bodies the porosity can be between about 25% and 50% and for porous aluminum the porosity can be between 50% and 70%, for example between 55% and 65%. Here below in tables 2, 3 and 4 for porous bodies 20 made of bronze, steel and aluminum examples are provided for suitable materials and some of their characteristics.

TABLE 2
Porosity 89/11 of sintered bronze

| Total | | Filtering |
|---|---|---|
| porosity | Pore size (μm) | efficiency × |

| Grade | (%) | Average | Maximum | (T = 98%) (μm) |
|---|---|---|---|---|
| B12 | 21 | 6 | 21.5 | 4 |
| B24 | 29 | 22 | 54 | 14 |
| B40 | 35 | 53 | 139 | 38 |
| B60 | 38 | 65 | 240 | 54 |
| B85 | 40 | 99 | 318 | 84 |
| B110 | 42 | 123 | 320 | 118 |
| B130 | 43 | 133 | 325 | 122 |
| B150 | 44 | 148 | 357 | 135 |
| B200 | 47 | 270 | 456 | 257 |

TABLE 3
Porosity sintered austenitic steel

| Total | | Filtering |
|---|---|---|
| porosity | Pore size (μm) | efficiency × |

| Grade | (%) | Average | Maximum | (T = 98%) (μm) |
|---|---|---|---|---|
| SSU2 | 25 | 1.7 | 5 | 1 |
| SSU5 | 37 | 7.6 | 20 | 5 |
| SSU10 | 37 | 10.9 | 30 | 7 |
| SSU15 | 37 | 13.5 | 33 | 8.5 |
| SSU25 | 37 | 26.5 | 50 | 17 |
| SSU40 | 50 | 39.0 | 127 | 25 |
| SSU60 | 43 | 59.5 | 198 | 37 |
| SSU80 | 50 | 83.7 | 199 | 54 |

TABLE 4
Porosity aluminum

| Parameter | No. 1 | No. 2 | No. 3 | No. 4 | No. 5 | No. 6 | No. 7 |
|---|---|---|---|---|---|---|---|
| Pore size, mm | 0.20- | 0.30- | 0.40- | 0.40- | 0.63- | 0.63- | 0.63- |
| | 0.35 | 0.50 | 0.63 | 1.00 | 1.60 | 3.00 | 4.00 |
| Filter grade, μm | 40- | 50- | 70- | 150- | 300- | 500- | 600- |
| | 50 | 60 | 90 | 200 | 400 | 600 | 700 |

| | |
|---|---|
| Volume porosity, % | 55-65 |
| Cell structure | all pores are open, |
| Aluminium alloy | AlSi7Mg |

These tables are only disclosed by way of example.

The or each mold cavity 2 in a mold 1 has a cavity surface 3A and each porous insert 7 has a porous surface 24 in the cavity surface 3A, facing the mold cavity 2, wherein the porous surface 24 of the one porous insert 7 or the combined porous surfaces of the porous inserts 7 of a mold cavity 2 has a surface area W which is smaller than half of a surface area Z defined by the cavity surface 3A, preferably significantly smaller, wherein the surface area Z is considered as a projected surface on the closure surface 9 or at least perpendicular to the opening and closure direction F of the mold 1. A mold cavity surface 3A should be understood as meaning the surface area defined by a male part 2A of a mold 1. By way of example in FIG. 3 the mold cavity surface area Z can be defined by the combined projected surfaces of the lid forming portion and the bottom forming portion, and the hinge forming portion 25 of a mold cavity 2, the surface area W of the inserts 7 can be defined by the end surfaces 24 of the inserts. By keeping the surface area W relatively small compared to the surface area Z pressure build up inside the mold cavity 2 can be controlled properly.

As discussed a mold 1 according to the disclosure can be used for baking a product P from a batter 5. To this end the mold 1 can be provided with at least one heating element 35 for heating the mold cavity 2 and material 5 inserted into said mold cavity 2. Heating elements 35 that can be used in or for a mold 1 according to the disclosure can for example be but not limited to steam powered heating elements, electrically powered heating elements, gas powered heating elements or the like heating elements as known in the art. The openings 8 can extend for example between the heating elements 35, as shown in FIGS. 1 and 3, or passed the openings 8.

During use of a mold 1 of the disclosure for forming a product, for example by heating, especially baking a product P from a batter, gas and/or vapor can develop inside the mold cavity 2. For example due to chemical reactions or by evaporation of a fluid, especially water, from the batter, or a combination thereof. Development of vapor can be advantageous in the mold 1 in order to increase the pressure inside the mold cavity 2 and for foaming of the batter, but excess vapor should preferably be removed from the mold cavity, for example, but not limited to, in order to ensure proper filling of the mold and proper forming of foam cells in the product and development of a product skin and for drying of the product P. As discussed openings 8 can be used for removing gas and/or vapor from a mold cavity 2. To this end the openings 8 can form channels 37 opening into an environment V of the mold 1 directly or via one or more spaces S inside the mold 1, relying on pressure of the gas and/or vapor and especially pressure difference between a higher pressure inside a cavity 2 and a lower pressure outside the cavity 2 in order to drive the gas and/or vapor out through the openings 8. However, in embodiments a pump 36 can be connected to the at least one porous insert 7, directly or via an opening 8 in which the insert 7 is provided, or via a system of channels 37 in communication with the openings 8, as schematically shown in FIGS. 1, 7 and 9. Such pump 36 can for example be used for actively sucking gas and/or vapor from the mold cavity 2.

Alternatively or additionally a pump 36 can be used for forcing pressurized gas, such as air, into the mold cavity 2 through the porous inserts 7 provided therein. By forcing such gas into the mold cavity 2 the gas can be used for expelling a product formed in the mold cavity 2 after opening the mold 1. An advantage of using such pressurized gas for expelling a product from a mold 1 is that traditional mechanical ejectors, such as pneumatic or hydraulic ejectors as are normally used in molding are no longer necessary, or at least to a lesser extent. This reduces complexity of the mold and molding apparatus as well as maintenance and operation thereof. Moreover use of gas such as air for expelling a product from a mold cavity 2 of a mold 1 reduces or even eliminates the chance of damage to the product. The pump 36 can in embodiments be a reversible pump 36, such that with the same pump 36 both gas and/or vapor can be removed from a cavity 2 and gas, such as air can be introduced into said cavity 2 for expelling a product P formed therein.

In an alternative embodiment, as shown schematically in FIGS. 7 and 9, the pump 36 can be connected to a three-way valve 51, such that a venturi effect can be used for reducing the pressure inside the space S and channels 8 and 37.

With a pump 36 connected to openings 8, prior to expelling the product P from the mold by forcing gas into the mold cavity 2, pressure can be reduced, especially when the mold 1 is still closed, by sucking air from the openings 8 and channels 37 and if applicable, the space S. This can be advantageous for example because moisture remaining behind the porous inserts 7, 20, i.e. between the porous bodies 20 and the pump 36, can be removed and expelled, before forcing gas into the mold cavity 3 for expelling the product. Thus it can be avoided that moisture, such as for example condensate gathered in the openings 8 or channels 37 or otherwise in the mold 1 is forced onto a product surface during expelling it from the mold cavity 2, which could result in damage to the product P or otherwise be detrimental to the product P, for example because of moisture content, undesired stickiness of the product surface or contamination.

By way of example, for forming a product P in a mold 1 in a process having a cycle time of 73 seconds, at about 55 second after injection of the material 5 into the mold cavity the pressure can actively be reduced in the channels 8, 37, by using the pump 36, for example to a near vacuum, removing any remaining vapor and free moisture from the mold 1, especially from the mold cavity 2 and openings 8 and porous inserts 7 and vents 30, if applicable. Then after about 70 seconds the mold can be opened, after which the product P can be formed out of the mold 1 by blowing air through the inserts 7 at about 73 seconds after injection of the material 5.

As discussed the or each porous insert 7 can be removably mounted in said mold wall 3, such that it can easily be placed and removed, for example to be cleaned outside the mold, or to be replaced, for example by another porous insert 7, which can be a similar insert 7 or a different type of insert, for example with a different porosity, different pore size, different material or the like.

A mold 1 according to the disclosure can be used for performing a method according to the disclosure. Such method can be a method for baking a product P from a liquid batter 5 in a mold 1, the mold 1 comprising a mold cavity 2 defined by at least a mold wall 3. A batter 5 is injected into the at least one mold cavity 2 and is heated inside said at least one mold cavity 2, during heating generating vapor from a liquid in the batter 5, which vapor creates pressure inside the at least one mold cavity 2, which can lead to foaming. The vapor is mostly removed from the at least one mold cavity 2 at least during said heating, wherein said vapor is removed from the at least one mold cavity 2 at least through at least one porous insert 7 provided in said mold wall 3. A porous insert 7 can e.g. be according to FIG. 5, using a porous body 20, or according to FIG. 6, using a porous body 20 in a sleeve 21. The batter 5 is kept inside the at least one mold cavity 2 at least by the at least one porous insert 7. An end surface 24 of the or each insert 7 forms part of the cavity wall 3 of the mold 1 and allows gas and vapor to pass out of the mold cavity 2 but stops solid matter from leaving the cavity 2.

In a method according to the disclosure a batter 5 can be used comprising solid matter such as at least natural polymers, such as starch, and a blowing agent, such as water.

In a method according to the disclosure in embodiments, especially using a batter such as a water based suspension of natural polymers, such as starch, a mold 1 can be used in which the porous inserts 7 have a combined surface area W facing the at least one mold cavity 3, wherein a product P formed inside the at least one mold cavity has a dry weight when removed from the mold cavity 2. The ratio of the combined surface area W of porous inserts 7 for the or each mold cavity 2 and the dry weight of the product P formed therein preferably is between 0.07 and 0.7 cm²/gram, preferably between 0.25 and 0.7 cm²/gram, such as between 0.3 and 0.5 cm²/gram. A dry weight of a product should in this context be understood as meaning a weight of a product P, formed in the mold 1 and expelled, having a remaining water content of less than 10% by weight, such as for example between 7% and 1% by weight, such as between 5% and 3% water by weight.

During heating of batter 5 inside the at least one mold cavity 2 preferably a vapor maximum pressure is created of between 1.5 and 6 bar overpressure, preferably between 1.5 and 4 bar overpressure, at least during part of the heating of the batter for forming a product P. It has been found that the pressure created inside the mold cavity 2 can be regulated by choosing the inserts 7, for example amending their porosity, by amending their cross section D₂₀ and/or height H and/or by choosing the material they are made of.

As discussed the vapor can be removed from the at least one mold cavity 2, wherein the rate of removing the vapor can be regulated by the inserts 7 and, if provide for, further vents 30, such as but not limited to vents at or near a closure surface 9 of the mold 1 as described here before and shown in e.g. FIGS. 2, 8 and 9. By removing part of the vapor the pressure inside the mold 1 can be controlled. Using additional vents 30, such as slit vents placed at parts of a mold cavity 2 which may be relatively difficult to fill with the material 5, such as for example ridges, edge portions or the like, can have the advantage that the slits 32 can aid in reducing pressure in these areas, enabling a better filling of the mold cavity 2, also in these parts or areas. Wherein the slits 32 can have such dimensions, especially a width, which is very small, such that no batter will exit the mold cavity 2 through said slit 30.

As discussed before, at or near the end of a molding cycle for molding a product in a mold cavity 2 preferably most, more preferably substantially all of the vapor and gasses, if applicable, have been or are removed from the mold cavity 2 and preferably from the mold 1. Thus the product will be substantially dry and can be removed from the mold 1. As discussed the moisture content, especially the water content of the product P can have been reduced to between about 3 and 5% by weight.

After heating the batter 5 inside the at least one mold cavity 2, especially after baking the product P, the mold 1 can be opened for removal of the product P. In embodiments a gas under pressure, such as air, can be inserted through at least one porous insert 7 into the mold cavity 3, forcing a product P formed in the at least one mold cavity 2 out of the mold cavity 2. Blowing the product P out of the mold cavity 2 by gas, such as compressed air, has advantages as discussed before. As discussed, preferably prior to inserting the gas under pressure through the at least one porous insert 7 into the mold cavity 2 vapor and condensed vapor is removed from behind the porous inserts 7, for example from the channels 8, 37 and the space S, by reducing pressure, such that the vapor is removed before inserting gas through at least the porous inserts 7.

FIG. 10 shows in a graph the pressure K inside a mold cavity 2 and the cycle time T for a mold 1 having mold cavities 2, of which each mold cavity 2 has a projected surface area of about 56,000 mm² and a volume of 0.1975 liter. The mold 1 was tested with different vent configurations, wherein a traditional plume vent (PV), a closure surface vent (CSV), a collar vent (CV) and an insert vent (IV) were used, as well as porous inserts 7 as described here before, in various combinations.

A CV is a vent 30 as described here before, referring to FIG. 8. A CSV is a vent 30 provided by slits 32 between the closure surfaces 9 of the mold, as schematically shown in FIG. 9, wherein the width is defined by the distance between the closure surfaces 9, measured perpendicular to said closure surfaces 9. An IV is a vent 30 provided by a slit 32 between a solid insert inserted into the wall 3A of the mold cavity 2 and the surrounding wall 3A of the mold cavity, wherein the width of the slit 32 is measured as the maximal distance between the insert and the surrounding wall 3A, measured parallel to the adjoining surface 3A, perpendicular to the periphery of said solid insert. Solid should in this respect be understood as at least not porous.

The traditional plume vent (PV) comprises substantially square openings of 1.2 mm by 1.2 mm, which allowed both vapor and part of the batter 5 to pass. Such PV vents are for example disclosed in WO2004/033179, between a mold cavity and an overdose channel as disclosed therein. The batter 5 passing through the PV vents was heated too, such that it gelatinized and at least partly baked, forming plumes. These formed plumes which had to be removed. The collar vents CV were used with a width of 0.05 mm and 0.1 mm. The closure surface vents CSV were used having a width of 0.1 mm. The insert vents IV had a width of 0.05 mm. No significant amount of batter entered into the CSV, IV or CV vents, when used.

The porous inserts 7 used were made of Bronze as defined in table 1, in the grade B85 according to table 2. Each insert 7 had a cylindrical porous body 20 with a flat end 24 with a diameter of 10 mm. The porous bodies 20 had a porosity of 40%. After closure of the mold 1 about 0.1975 liter of batter 5 was injected into each of the mold cavities 2, completely filling the mold cavities.

As can be seen in FIG. 10, in broken line L₁ the pressure inside the mold cavity 2 rose to about 3.5 Bar in about 20 seconds, and then fell relatively slowly to a atmospheric level at the end of the cycle time of 80 seconds. This graph L₁ is taken as a reference line. The solid black line L₂ in FIG. 10 shows the pressure in a mold 1 having a 0.1 mm width CV, a 0.1 mm CSV and a 0.05 mm IV. As can be seen in FIG. 10 the pressure rose more quickly inside the mold cavity 2, up to about 5.4 Bar after about 25 seconds, to then drop to atmospheric level, with a cycle time T of 85 seconds. The light green line L₃ in FIG. 10 shows the pressure inside the mold cavity 2 for a mold having a 0.1 mm width CV, a 0.1 mm CSV and a 0.1 mm IV. As can be seen in FIG. 10 the pressure rose relatively quickly inside the mold cavity 2, up to about 4.57 Bar after about 25 seconds, to then drop to atmospheric level, with a cycle time T of 83 seconds. The lines L₄-L₁₀ in FIG. 10 show the pressure K inside the mold cavity 2 over time during a molding cycle, with 1 to 7 porous inserts respectively. As can be seen in FIG. 10 and table 5, the porous inserts 7 reduced the maximum pressure K inside the mold cavity 2, wherein the pressure build up inside the mold cavity 2 was slightly more gradual than in the reference mold with the plume vents PV. The cycle time T was reduced with an increasing number of porous inserts 7.

TABLE 5
pressure and cycle time for different mold vent configurations

| Ontluchting | Gemiddelde maximale druk | Cyclustijd |
|---|---|---|
| 1.2 × 1.2 | — | 60 |
| pluimen* | | |
| 7 poreus | 3.13 | 70 |
| 6 poreus | 3.47 | 73 |
| 5 poreus | 3.56 | 75 |
| 4 poreus | 3.82 | 77 |
| 3 poreus | 3.91 | 78 |
| 2 poreus | 4.20 | 80 |
| 1 poreus | 4.42 | 82 |
| 0.1 mm insert | 4.57 | 83 |
| 0.05 mm insert | 5.42 | 85 |

From these tests it follows that the reduction of cycle time is substantially linear with the increase of the porous surface area W in the mold cavity wall 3A of the porous inserts 7. A total number of 12 porous inserts 7 as described in a mold as disclosed here above will thus for example provide an internal maximum pressure K of about 2 Bar, with a cycle time of about 60 seconds, hence a cycle time comparable to the cycle time of the mold 1 having the plume vents PV only, but with a significantly lower maximum pressure K in the mold cavity 2. This for example results in this mold 1 in about 10 cm² porous surface area of the porous bodies 20 of the porous inserts 7, for a product P made of a batter 5 comprising at least natural polymers such as starch and water, as for example discussed in example 1 here below, the product P having a dry weight of 32 gram, or a porous surface to dry weight ratio of 0.31 cm²/gram.

A mold 1 according to the disclosure can be made by forming at least one mold cavity 2, wherein into and preferably through a wall 3 of said at least one mold cavity 2 at least one opening 8 is formed. Into said at least one opening 8 an insert 7 is inserted, wherein the insert 7 is formed having at least a porous body 20, such that during use for making a product P in the mold 1 vapor generated in the mold cavity 2 can be removed therefrom through the at least one porous body 20, keeping the material 5 of which the product is formed inside the cavity 2. When using substantially cylindrical porous inserts 7 the advantage can be obtained that the openings 8 can easily be drilled into the wall 3. More in general openings 8 for inserts 7 can for example be made by drilling or milling of the opening or openings 8 in the wall 3.

Here below examples will be provided of methods for forming a product P in a mold 1 according to the disclosure, by way of example only.

### EXAMPLE 1

In a mold 1 according to FIGS. 2 and 3 egg trays were made as products P, using a batter 5 as disclosed in Table 5 here below. The egg trays were generally as disclosed in EP3470345, and are shown by way of example for a product P only, and should not be considered limiting the disclosure.

TABLE 5
recipe 1.

| | | |
|---|---|---|
| water | 1.500 | ml |
| silicon HY oil | 22 | ml |
| potato starch food grade | 1000 | grams |
| hydroxyl-apatite | 2 | grams |
| china clay spec | 75 | grams |
| hydrocarb 95T | 75 | grams |
| Xanthan gum Koltrol P | 2 | grams |
| Guar gum | 8 | grams |
| Cellulose white | 120 | grams |
| (approximately 2.5 mm) | | |

The mold 1 had two mold cavities 2, as shown FIG. 3, and had a projected surface area of 256 times 217 mm, or about 56,000 mm² and the combined mold cavities has a volume of 0.1975 liter. For each mold cavity seven porous inserts 7 were provided, made of Bronze as defined in table 1, in the grade B85 according to table 2. Each insert 7 had a cylindrical porous body 20 with a flat end 18 with a diameter of 10 mm. The combined porous bodies therefore had a surface area in the cavity of 5.5 cm². The porous bodies 20 had a porosity of 40%. The mold 1 further had a slit vent 30 as shown in FIG. 8 along the periphery of the mold cavities 2, with a width of the slit of 0.05 mm.

The mold 1 was closed, having the closing surface 9 extending vertically, as shown in FIG. 4. After closure of the mold 1 about 0.1975 liter of batter 5 was injected into each of the mold cavities 2, completely filling the mold cavities 2. The mold 1 was subsequently heated to a baking temperature for the batter 5, during which heating part of the water in the batter evaporated due to heating, building pressure inside the mold cavities 2, acting as a blowing agent. Inside the mold cavities 2 a maximum pressure was obtained of about 3,13 bar overpressure, because vapor was expelled from the mold cavities 2, through the porous inserts 7 and slit vent 30.

The cycle time for baking the products P in the mold was 70 seconds. After 70 seconds the mold 1 was opened and the products P removed from the mold. The products had a moisture content of between 3% and 5% by weight. No batter 5 had left the mold cavity through the porous inserts 7. The product was substantially as disclosed in EP3470345.

### EXAMPLE 2

The experiment of example 1 was repeated, but the mold 1 used had only two porous inserts 7 per mold cavity 2, together defining a porous surface area of about 1.6 cm². The batter 5 was heated in the mold 1 at the same temperature as in example 1, baking the product P. The cycle time was 80 seconds, whereas the maximum pressure inside the mold cavities 2 was about 4.2 bar overpressure.

### EXAMPLE 3

The experiment of example 1 was repeated, but in a mold without porous inserts 7. The mold had a slit vent 31 as shown in FIG. 8 along the periphery of the mold cavities 2, with a width of 0.05 mm. Again the same product P was made in the mold, with a cycle time of 85 seconds, and a maximum pressure inside the mold cavities 2 of about 5.42 bar overpressure.

### EXAMPLE 4

The experiment of example 1 was repeated, but the mold only had seven porous inserts 7. In this experiment the cycle time was 90 seconds, with maximum pressure in the mold cavities 2 of 5 bar overpressure.

### EXAMPLE 5

The same example was used as example 1. However, in this example after about 55 second after injection of the batter 5 the pressure inside the mold cavities 2 was actively reduced by sucking all free air and moisture out of the mold 1 using a pump 36. Then after 70 seconds after injection the mold 1 was opened. The product P was then ejected out of the mold 1, especially off the male part 2A of the mold 1, by forcing compressed air through the porous inserts 7 against the product P. The products P came off the male part 2A easily and without visible damage to the product P.

It was found that the height of the inserts 7 was of relatively little relevance to the function thereof. The experiments discussed here before are only shown by way of example and should by no means be considered as limiting the scope of protection in any way.

It has been found that the porous inserts can be kept clean over a relatively long period of time, meaning that no significant amount of batter will enter into the porous body 20, maintaining sufficient porosity of the porous body 20. For example, in a process as described in example 1 it was found that the flow of air through the porous body 20 reduced from 100% at the start to about 82% after four days of continuous baking in the mold 1, and to about 79% after 12 days, after which the flow did remain relatively constant for days. It was found that the inserts 7 could easily be removed from the openings and cleaned, for example by rinsing the inserts 7, especially the porous bodies 20.

The invention is by no means limited to the embodiments shown in the description and drawings. Many variations thereof are possible.

For example molds can be used having different numbers of mold cavities, such as for example only one or more than two. The number of porous inserts 7 as well as the shape and dimensions can be chosen differently, for example for amending the pressure inside the mold cavities 2 or for optimizing flow of air into and/or out of the mold cavity. In the embodiments shown the porous inserts 7 or at least the porous bodies 20 in or for a mold cavity all have the same configuration. In embodiments however also different porous inserts and/or different bodies 20 can be used, in or for the same mold cavity 2, for example made of different materials, and/or having different porosities, different cross sections and sizes or combinations thereof. Different materials can be used in the molds and methods for producing products, such as but not limited to batter comprising natural polymers different from starch, or combinations of different polymers. The material can comprises also non-natural polymers, fibers, other blowing agents and the like. Especially other batters can be used, for example but not limited to as known from U.S. Pat. No. 6,641,758, WO96/30186, WO2004033179 or US2019/0367221. In embodiments the material can be placed in the mold cavities prior to closure of the mold. Closures can be provided for openings 8, such as valves, for during use of the molds temporarily closing one or more of the openings, for controlling the flow of vapor and/or gasses into and/or out of the mold cavities.

These and various other amendments should be considered as having been disclosed herein too.

1. A mold comprising at least one mold cavity defined by at least a mold wall, wherein at least one part of said wall is a porous part, wherein the at least one porous part is formed by or comprises a porous insert inserted into an opening extending into and preferably through said wall.

2. The mold according to claim 1, wherein the at least one porous insert is or comprises a porous body.

3. The mold according to claim 2, wherein the porous body is made of metal.

4. The mold according to claim 2, wherein the porous body is comprised in a sleeve.

5. The mold according to claim 1, wherein a series of porous inserts is provided in said wall, preferably at least two porous inserts.

6. The mold according to claim 1, wherein the at least one porous inserts forms a first vent for the mold cavity, wherein at least one further vent is provided for the mold cavity.

7. The mold according to claim 1, wherein the porous inserts are made using sintered material, especially sintered metal or ceramics.

8. The mold according to claim 1, wherein the at least one porous insert or a porous body of such insert has a porosity of at least 15%, preferably at least 20%.

9. The mold according to claim 1, wherein the mold cavity has a cavity surface and each porous insert has a porous surface in the cavity surface, facing the mold cavity, wherein the porous surface of the one porous insert or the combined porous surface of the porous inserts has a surface area which is smaller than half of a surface area defined by the cavity surface.

10. The mold according to claim 1, wherein the mold comprises at least one heating element for heating the mold cavity and material inserted into said mold cavity.

11. The mold according to claim 1, wherein the mold is provided with or connected to an injector for batter into the mold cavity.

12. The mold according to claim 1, wherein a pump is connected to the at least one porous insert.

13. The mold according to claim 1, wherein the at least one porous insert is designed for at least keeping batter inside the at least one mold cavity and removing vapor generated from the batter from the at least one mold cavity.

14. The mold according to claim 1, wherein the at least one porous insert is removably mounted in said mold wall, such that it can be cleaned outside the mold.

15. A method for baking a product from a liquid batter in a mold, the mold comprising a mold cavity defined by at least a mold wall, wherein a batter is injected into the at least one mold cavity and is heated inside said at least one mold cavity, during heating generating vapor from a liquid in the batter, which vapor creates pressure inside the at least one mold cavity and which vapor is removed from the at least one mold cavity at least during said heating, wherein said vapor is removed from the at least one mold cavity at least through at least one porous insert provided in said mold wall, whereas the batter is kept inside the at least one mold cavity at least by the at least one porous insert.

16. The method according to claim 15, wherein a batter is used comprising at least natural polymers, such as starch, and water.

17. The method according to claim 15, wherein a mold is used in which the porous inserts have a combined surface area facing the at least one mold cavity, wherein a product formed inside the at least one mold cavity has a dry weight and wherein the ratio of the combined surface area for the or each mold cavity and the dry weight of the product formed therein is between 0.07 and 0.7 cm²/gram, preferably between 0.25 and 0.7 cm²/gram, such as between 0.3 and 0.5 cm²/gram.

18. The method according to claim 15, wherein during heating of the batter inside the at least one mold cavity a vapor pressure is created of between 1.5 and 6 bar overpressure, preferably between 1.5 and 4 bar overpressure.

19. The method according to claim 15, wherein after heating the batter inside the at least one mold cavity the mold is opened and a gas under pressure is inserted through at least one porous insert into the mold cavity, forcing a product formed in the at least one mold cavity out of the mold cavity.

20. The method according to claim 19, wherein prior to inserting the gas under pressure through the at least one porous insert vapor and condensed vapor is removed from the mold by reducing pressure in the mold.

21. A method for forming a mold, wherein a mold having at least one mold cavity is formed, wherein into, preferably through a wall of said at least one mold cavity at least one opening is formed, into which at least one opening an insert is inserted, wherein the insert is formed having at least a porous body, such that during use vapor generated in the mold cavity can be removed therefrom through the at least one porous body.

22. The method according to claim 21, wherein the at least one opening is drilled or milled into or through said wall.
